(19) United States
(12) Patent Application Publication
(10) Pub. No.: US 2025/0194596 A1
(43) Pub. Date: Jun. 19, 2025

(54) Use of Chlorogenic Acid and Chlorogenic Acid-Rich Substance in Control of Citrus Huanglongbing (HLB)

(71) Applicants: Huazhong Agricultural University, Wuhan City (CN); Hubei Hongshan Laboratory, Wuhan City (CN)

(72) Inventors: Qiang Xu, Wuhan City (CN); Wang Zhang, Wuhan City (CN); Kun Yang, Wuhan City (CN); Yuantao Xu, Wuhan City (CN); Xiuxin Deng, Wuhan City (CN)

(21) Appl. No.: 18/653,264

(22) Filed: May 2, 2024

(30) Foreign Application Priority Data
Dec. 18, 2023 (CN) 2023117442215

(51) Int. Cl. A01N 37/38; A01N 25/30; A01P 1/00

(52) U.S. Cl. CPC A01N 37/38; A01N 25/30; A01P 1/00

(57) ABSTRACT

Provided is a use of chlorogenic acid and a chlorogenic acid-rich substance in control of citrus huanglongbing (HLB); where a bacteriostatic agent includes the chlorogenic acid, and the chlorogenic acid has an effective concentration of greater than or equal to 0.5 mg/mL. In the present disclosure, an antibacterial test of the chlorogenic acid on Candidatus Liberibacter asiaticus (CLas) has confirmed that the chlorogenic acid shows a significant inhibitory effect on the CLas. It is also proven in the field that application of the chlorogenic acid exhibits an obvious therapeutic effect on diseased trees to be treated, indicating application prospects of the chlorogenic acid in controlling the citrus HLB. Moreover, the chlorogenic acid, as a green, natural, and non-toxic bioactive substance, is widely used in medical, food, and health care industries, with convenient sources, controllable costs, and strong feasibility.

### CROSS-REFERENCE TO RELATED APPLICATION(S)

This patent application claims the benefit and priority of Chinese Patent Application No. 2023117442215, filed with the China National Intellectual Property Administration on Dec. 18, 2023, the disclosure of which is incorporated by reference herein in its entirety as part of the present application.

### TECHNICAL FIELD

The present disclosure relates to the field of citrus disease control, and specifically relates to use of chlorogenic acid and a chlorogenic acid-rich substance in control of citrus huanglongbing (HLB).

### BACKGROUND

Huanglongbing (HLB) is the most serious and devastating disease in citrus production with huge losses, posing a serious threat to the sustainable development of the citrus industry around the world. HLB is also known as the “cancer” of citrus. Citrus trees infected with the HLB show significant growth retardation, serious decline in yield and fruit quality, and ultimately cause tree death. As the largest citrus producer in the world, China currently has not less than 80% of a total area affected by HLB with a tendency to spread, causing huge losses to the citrus industry and fruit farmers.

Citrus HLB is a worldwide problem mainly because Candidatus Liberibacter asianticum (CLas) cannot be cultured in vitro, thereby bringing great difficulties to the screening and development of chemical agents with obvious inhibitory effects. So far, a control strategy of the HLB mainly includes removal of diseased trees by digging, planting virus-free seedlings, and spraying drugs to kill psyllids (transmission vectors), commonly known as the “three-pronged approach”. The state of Florida in the United States began allowing the use of antibiotics to combat HLB disease in 2018. However, this strategy may have adverse effects on the environment and human health, and can also lead to the potential development of antibiotic resistance in CLas. Developing natural metabolites to inhibit the CLas has become an ecologically safe, green, and controllable strategy.

Currently known citrus cultivated varieties are susceptible to HLB, while wild citrus resources show obvious tolerance. Therefore, it is of great significance to the control of HLB and reducing the losses of citrus industry by identification metabolites from wild disease-tolerant resources and developing greener and more efficient antibacterial metabolites.

### SUMMARY

In order to overcome the shortcomings of the existing technology, an objective of the present disclosure is to provide use of chlorogenic acid and a chlorogenic acid-rich substance in control of citrus HLB. In the present disclosure, citrus resources with excellent disease tolerance properties are obtained through screening and identification of a large number of wild citrus resources and local citrus varieties for many years. After comparing and screening the metabolome of disease-tolerant citrus and susceptible citrus, a green and safe metabolite that can significantly inhibit the activity of CLas, chlorogenic acid, has been identified in high level in disease-tolerant varieties of Australian finger lime, kumquat, Yichang papeda, and trifoliate orange. The chlorogenic acid shows a significant inhibitory effect on CLas. In particular, the chlorogenic acid can activate citrus defense responses and salicylic acid signaling pathways. Accordingly, the chlorogenic acid is a plant-derived metabolite that can be used to inhibit CLas. Chlorogenic acid is mainly extracted from Chinese herbal plants of Caprifoliaceae and Eucommiaceae, and is a green, natural, and non-toxic bioactive substance. The chlorogenic acid is widely used in medical, food, health care and other industries with a low cost, and is feasible for application in the agricultural production.

In order to achieve the above objective, the present disclosure adopts the following technical solutions:

The present disclosure provides use of chlorogenic acid and a chlorogenic acid-rich substance in control of CLas.

The chlorogenic acid (molecular formula: C₁₆H₁₈O₉; molecular weight: 354.31; CAS number: 327-97-9), a white powdery chemical reagent (FIG. 1), is slightly easily soluble in water (with a solubility of 4% in 25° C. water) and easily soluble in ethanol, and a resulting solution is colorless and transparent. The chlorogenic acid can achieve a significant inhibitory effect on CLas at a concentration of not less than 5 mg/mL, and can be used to control the citrus HLB.

The present disclosure further provides use of chlorogenic acid and a chlorogenic acid-rich substance in preparation of a bacteriostatic agent for citrus HLB.

Further, the chlorogenic acid-rich substance is a green coffee bean extract.

The present disclosure further provides a bacteriostatic agent for controlling CLas, where the bacteriostatic agent includes chlorogenic acid or a chlorogenic acid-rich substance, and the chlorogenic acid has an effective concentration of greater than or equal to 0.5 mg/mL.

Further, the chlorogenic acid has an effective concentration of 0.5 mg/mL to 5.0 mg/mL.

Furthermore, the chlorogenic acid has an effective concentration of 5.0 mg/mL (an appropriate concentration considering a solubility of the chlorogenic acid in water is 4% at 25° C. and an excessive concentration may cause difficulty in dissolution).

Furthermore, the bacteriostatic agent further includes rhamnolipid.

Furthermore, the rhamnolipid in the bacteriostatic agent has an effective concentration of 1 mg/mL.

The rhamnolipid is a biosurfactant that is widely used in the agricultural field and has the functions of assisting in the absorption of nutrients and enhancing an absorption effect of pesticides and fertilizers. Moreover, it has been confirmed that the rhamnolipid has no toxic or side effects on human beings and animals.

The present disclosure further provides a method for inhibiting CLas, including: injecting the bacteriostatic agent into the HLB-infected tree by leaf injection or trunk injection.

Preferably, the method specifically includes the following steps:

Pricking a small hole on a back side of a HLB-infected leaf with a needle, and injecting the chlorogenic acid solution through a syringe to fill mesophyll cells (where the bacteriostatic agent can be effective in 3 d, and then a lasting effect is observed); and/or,
on a HLB-infected citrus tree, punching a small hole at a base of the trunk using an electric drill, and injecting a chlorogenic acid solution into an interior of the infected tree through trunk injection, where an injection volume for each diseased citrus tree is adjusted to 200 mL to 350 mL according to a size of the tree (where a content of CLas is significantly reduced in 1 month, HLB symptoms are relieved, and the tree vigor is enhanced).

The ideas of the present disclosure are as follows:

In the present invention, HLB tolerance has been evaluated on wild citrus and Citrus-related genera resources for many years, and a number of citrus germplasm resources are selected with excellent disease tolerance. By analyzing the differential metabolites of HLB-tolerant varieties and susceptible varieties, it is found that the tolerant varieties Australian finger lime, Yichang papeda, trifoliate orange, and kumquat have a significant accumulation of the chlorogenic acid, while the susceptible varieties sweet orange and pummelo hardly accumulate the chlorogenic acid. Therefore, chlorogenic acid is selected to test its antibacterial activity by injecting into HLB-infected leaves and sweet orange trees, respectively, to develop antibacterial agent.

The present disclosure has following beneficial effects:

In the present disclosure, an antibacterial test of the chlorogenic acid on CLas has confirmed its significant inhibitory effect. It is also proven that the chlorogenic acid exhibits an obvious therapeutic effect on HLB-trees, proving its application prospects in controlling citrus HLB. Meanwhile, the chlorogenic acid is mainly extracted from Chinese herbal plants of Caprifoliaceae and Eucommiaceae, and is a green, natural, and non-toxic bioactive substance. The chlorogenic acid is widely used in medical, food, health care and other industries. Therefore, the safety of chlorogenic acid can be secured. This is the first application of plant metabolite to the control of CLas. Chlorogenic acid has a significant inhibitory effect on CLas. Injection of the chlorogenic acid into the mesophyll for 3 days or injection into the tree trunks for one week can reduce a CLas content by about 60%, and an antibacterial effect is better than oxytetracycline hydrochloride which approved for use by the Department of Agriculture and Environmental Protection, US. Moreover, the chlorogenic acid causes no toxic effect on both citrus and human body, thus shows broad application prospects in the control of HLB.

### BRIEF DESCRIPTION OF THE DRAWINGS

FIG. 1 shows the structure and molecular formula of chlorogenic acid;

FIGS. 2A-2C show the identification diagram of HLB-tolerant citrus resources; where

FIG. 2A is the phenotypic diagram of disease-tolerant citrus resources after grafting and inoculation with HLB, from left to right are trifoliate orange, Yichang papeda, Australian finger lime, and kumquat;

FIG. 2B is the phenotype diagram of susceptible citrus resources after grafting and inoculation with HLB, the upper left is sweet orange, the lower left is pummelo, and the right is Ponkan mandarin;

FIG. 2C is a graph showing the bacterial content of the scions after grafting and inoculating HLB to disease-tolerant and susceptible citrus resources; and

*** indicates that there is a significant difference in a Ct value at the P<0.001 level;

FIG. 3 shows the comparison of leaf metabolome of disease-tolerant and susceptible citrus resources; where

the disease-tolerant resources include Australian finger lime (AZM), trifoliate orange (ZK), kumquat (SJJ), and Yichang papeda (YCC); the susceptible resources include Zipiyou pummelo (ZPY), Wanbai pummelo (WBY), Valencia sweet orange (HXC), and Dahong sweet orange (DH);

FIG. 4 shows the screening effect of an optimal inhibitory concentration of chlorogenic acid, the antibacterial metabolite of CLas; where

the Ct value is converted into a content of pathogenic bacteria, and changes in the content of pathogenic bacteria before and after treatment is calculated and expressed as a percentage; positive values indicate an increase in bacterial content, and negative values indicate a decrease in bacterial content; and

* and ** indicate significant differences in Ct values at P<0.05 and P<0.01 levels, respectively, while ns indicates no significance;

FIG. 5A-5D show the comparison of antibacterial effects of chlorogenic acid and antibiotics; where

FIG. 5A to FIG. 5C represent the detection results of CLas content after 3 d of ampicillin, oxytetracycline hydrochloride, and chlorogenic acid mesophyll injection treatment, respectively;

FIG. 5D represents the comparison of the antibacterial effects of ampicillin, oxytetracycline hydrochloride, and chlorogenic acid; and

the Ct value is converted into a content of CLas, and changes in the content of CLas before and after treatment is calculated and expressed as a percentage; * and ** indicate significant differences in Ct values at P<0.05 and P<0.01 levels, respectively;

FIG. 6 shows the leaf effects after mesophyll injection of green coffee bean extract rich in chlorogenic acid to treat HLB; where

indicates that there is a significant difference in Ct values at the P<0.001 level;

FIGS. 7A-7B show the leaf effects after mesophyll injection of bacteriostatic agent 1 to treat HLB; where

FIG. 7A is a schematic diagram of the mesophyll injection of bacteriostatic agent 1;

FIG. 7B is the detection of CLas content in HLB-infected leaves of control group and bacteriostatic agent 1 group on the 3rd and 7th day after injection; and

* and *** indicate significant differences in Ct values at P<0.05 and P<0.001 levels, respectively, while ns indicates no significance;

FIGS. 8A-8B show the effect of trunk injection and infusion of bacteriostatic agent 1 on treating HLB-infected trees; where

FIG. 8A is a schematic diagram of the trunk injection and infusion of the bacteriostatic agent 1;

FIG. 8B is the detection of CLas content in leaves of HLB-infected trees for 4 consecutive weeks after the trunk injection treatment with the bacteriostatic agent 1; and

* and *** indicate significant differences in Ct values at P<0.05 and P<0.001 levels, respectively;

FIGS. 9A-9D show the therapeutic effect of the bacteriostatic agent 1 on seven commercial citrus varieties; where

FIG. 9A(1)-9A(7) are the tree vigor of HLB-infected trees of 7 citrus varieties before and after treatment with the bacteriostatic agent 1;

FIG. 9B is the number of new shoots extracted from the HLB-infected mandarin trees and control group after the bacteriostatic agent 1 treatment;

FIG. 9C(1)-9C(4) and FIG. 9D(1)-9D(4) are the statistics of the size and single fruit weight of the diseased fruits in the control group and the bacteriostatic agent 1 treatment group; and

*** and **** indicate significant differences in statistical data at the P<0.001 and P<0.0001 levels, respectively; and

FIG. 10 shows that a bacteriostatic agent 4 improves an antibacterial effect of the bacteriostatic agent on CLas.

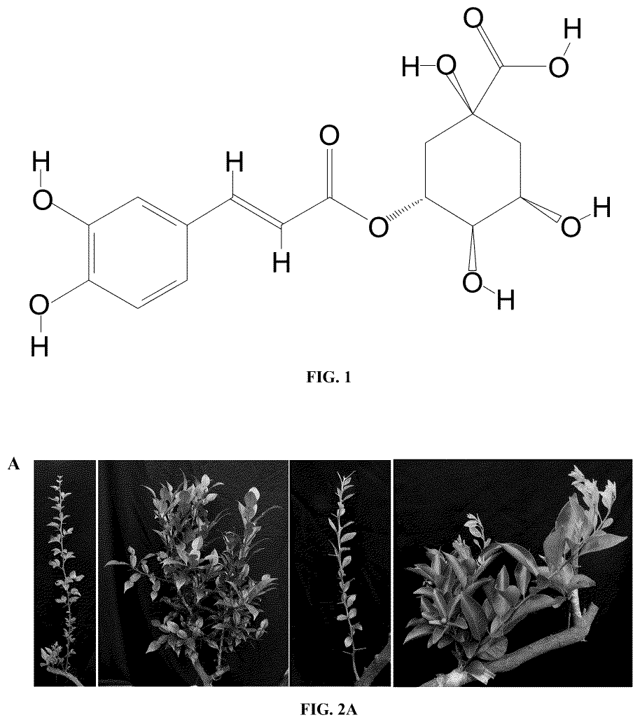

### DETAILED DESCRIPTION

The present disclosure will be described in further detail below in conjunction with specific examples to facilitate understanding by those skilled in the art.

### Example 1 Identification of HLB-Tolerant Citrus Resources

HLB tolerance evaluation trials of candidate citrus varieties were conducted in HLB-infected orchards. Infected trees with obvious HLB symptoms but desirable growth were selected as rootstocks, and candidate citrus varieties were randomly grafted to different parts of the rootstock through bud grafting. About 1 to 3 months after grafting, germination began and the branches were developed. The mature leaves were used for CLas content detection and phenotypic observation.

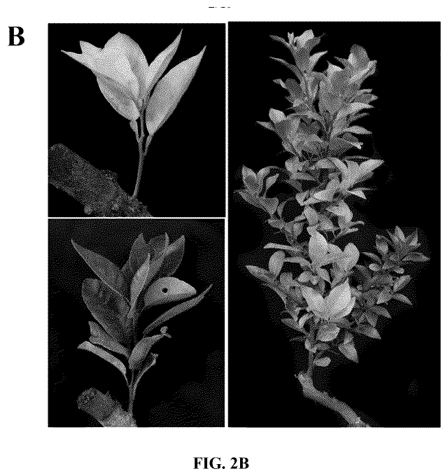

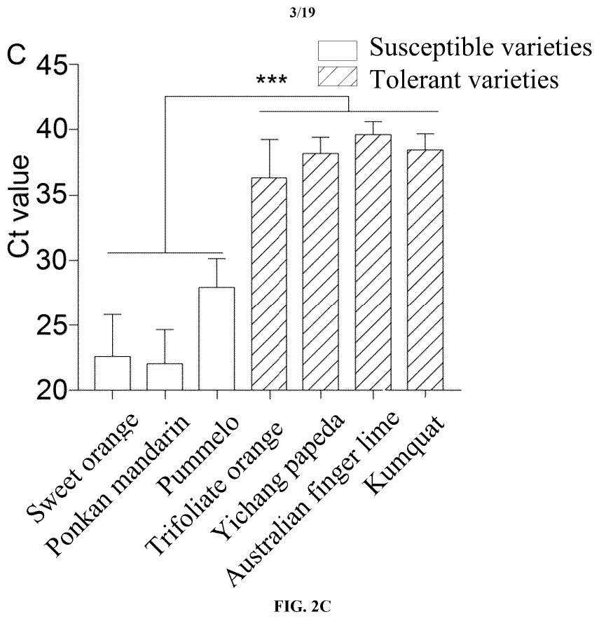

The results of the HLB tolerance evaluation test indicated that trifoliate orange, Australian finger lime, kumquat, and Yichang papeda showed strong tolerance, vigorous growth, and almost undetectable CLas content (a bacterial content was indicated by Ct value, which was negatively correlated with the bacterial content, FIGS. 2A-2C).

### Example 2 Metabolome Comparison of HLB-Tolerant and Susceptible Citrus Germplasm

Based on the above HLB tolerance evaluation test, varieties with excellent tolerance were identified, such as trifoliate orange, Australian finger lime, kumquat, and Yichang papeda. Through comparative metabolomics, the leaf metabolome of selected HLB-tolerant varieties and typical susceptible varieties such as sweet orange and pummelo were measured and compared.

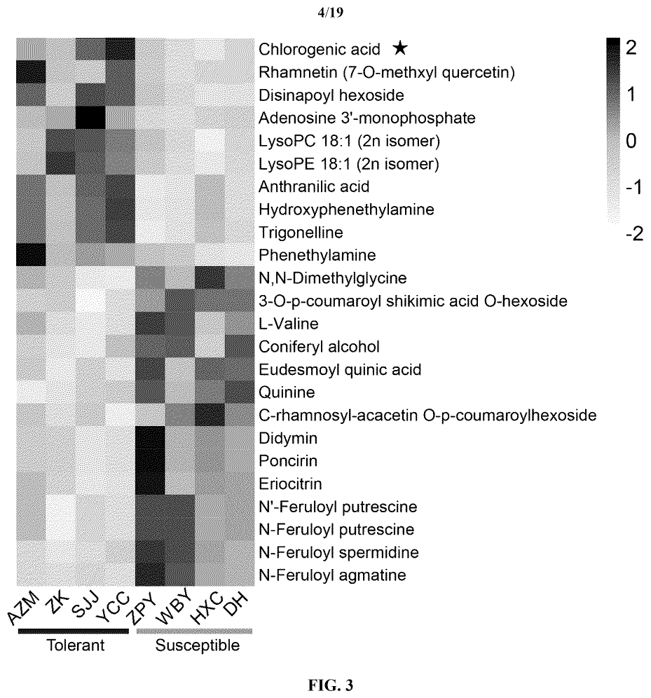

A total of 375 metabolites were detected between the tolerant and susceptible group, of which the contents of 24 metabolites were significantly different. It was worth noting that 10 metabolites were highly accumulated in the tolerant varieties and were potential inhibitors of CLas, including phenylalanine, lysophosphatidylcholine, quercetin derivatives, trigonelline, and chlorophyll acid (FIG. 3). Considering solubility, lipids and flavonoids were not soluble in water, and trigonelline was too expensive. However, chlorogenic acid was green and non-toxic with desirable solubility in water and low cost, thus exhibiting great research and application values.

### Example 3 Concentration Screening of Chlorogenic Acid

HLB-infected leaves were treated with chlorogenic acid at concentrations of 0/0.05/0.5/5/10 mg/mL through mesophyll injection separately, with at least three replicates for each concentration; leaf disc samples were collected before treatment as a control, and collected again after 3 d to detect changes in CLas content.

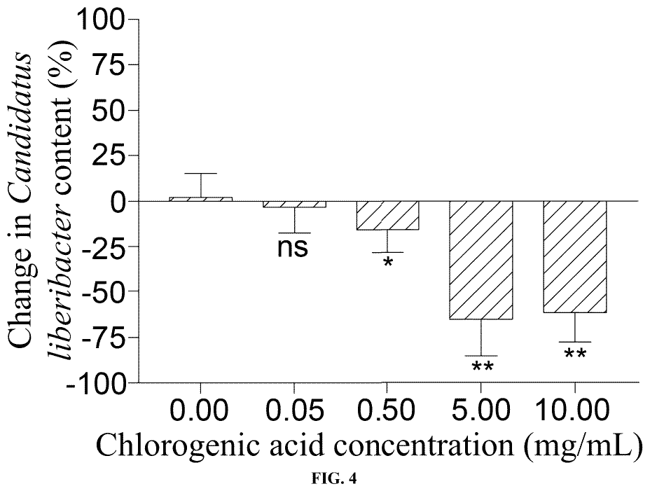

The results showed that when the chlorogenic acid treatment concentration was 0.5 mg/mL, the CLas content in diseased leaves decreased to a significant level, indicating that 0.5 mg/mL might be a minimum inhibitory concentration (MIC) of chlorogenic acid for CLas. However, the antibacterial effect on CLas was not obvious at concentrations below 0.5 mg/mL. The effect became more obvious as the concentration increased from 0.5 mg/L to 5 mg/mL; however, when the concentration was increased to 10 mg/mL, the inhibitory effect was not further improved and was equivalent to that of 5 mg/mL (FIG. 4). Moreover, since chlorogenic acid had a solubility of 4% in water at 25° C., the chlorogenic acid solution became turbid at this concentration, which not only affected the absorption of leaves but also greatly increased the cost of use. Therefore, the optimal antibacterial concentration of chlorogenic acid should be 0.5 mg/mL to 5 mg/mL.

### Example 4 Comparison of the Antibacterial Effects of Chlorogenic Acid and Antibiotics

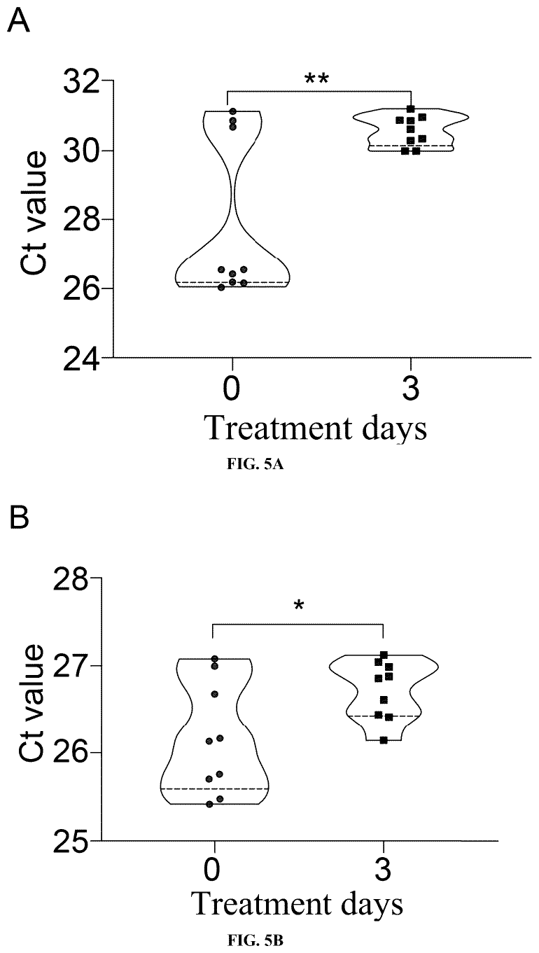

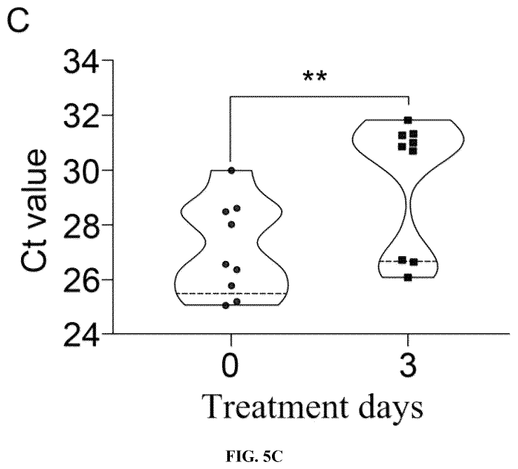

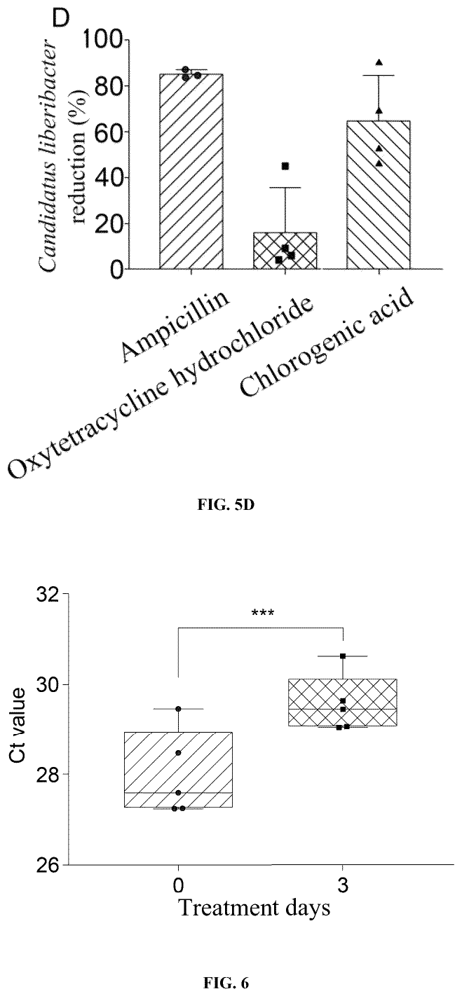

The ampicillin had a concentration of 12 mg/mL, the oxytetracycline hydrochloride had a concentration of 20 mg/mL, and the chlorogenic acid had a concentration of 0.5 mg/mL. The above substances were injected into the mesophyll (FIG. 5A to FIG. 5C).

The results showed that the ampicillin had the best antibacterial effect, and the CLas content was reduced by more than 80%; the antibacterial effect of the bacteriostatic agent (containing chlorogenic acid) was better than that of oxytetracycline hydrochloride approved for use by the Department of Agriculture and Environmental Protection, US, and the CLas content was reduced by more than 60%; the reduction of CLas content after treatment with oxytetracycline hydrochloride was about 20% (FIG. 5D).

### Example 5 Effect of Mesophyll Injection of Green Coffee Bean Extract on HLB-Infected Leaves

Green coffee beans are one of the substances richest in chlorogenic acid, and the chlorogenic acid content of its extract, green coffee powder, can reach up to 50% (the highest content among all currently sold products). The green coffee powder was added to water to prepare a solution with an effective concentration of chlorogenic acid of 5 mg/mL. Leaves infected with CLas were treated by mesophyll injection, and the CLas content was detected after 3 d of treatment.

The results showed that the CLas content in the diseased leaves was significantly reduced after 3 d (the bacterial content was expressed as a Ct value, which was negatively correlated with the bacterial content, FIG. 6). When the concentration of the green coffee powder solution was increased, the solution became brown-green and turbid and viscous, with increased impurities that could easily block the needle tube and the substance of the diseased tree, making it impossible to treat HLB-infected trees.

### Example 6

A bacteriostatic agent 1 for controlling CLas included chlorogenic acid, where the chlorogenic acid had an effective concentration of 5 mg/mL.

A preparation method of the bacteriostatic agent 1 for controlling CLas included:

50 mg of a chlorogenic acid solid powder (purity: >98%, coolaber, Beijing, China) was dissolved in 10 mL of water to obtain a solution with a concentration of 5 mg/mL, which was the bacteriostatic agent 1.

Depending on the actual situation, a green coffee bean extract might also be weighed to replace the chlorogenic acid to prepare the bacteriostatic agent.

### Example 7

A bacteriostatic agent 2 for controlling CLas included chlorogenic acid, where the chlorogenic acid had an effective concentration of 0.5 mg/mL.

### Example 8

A bacteriostatic agent 3 for controlling CLas included chlorogenic acid, where the chlorogenic acid had an effective concentration of 2.5 mg/mL.

### Example 9

A bacteriostatic agent 4 for controlling CLas included chlorogenic acid and rhamnolipid, where the chlorogenic acid had an effective concentration of 5 mg/mL, and the rhamnolipid had an effective concentration of 1 mg/mL.

### Example 10 Significant Inhibition of CLas by Leaf Injection with Bacteriostatic Agent

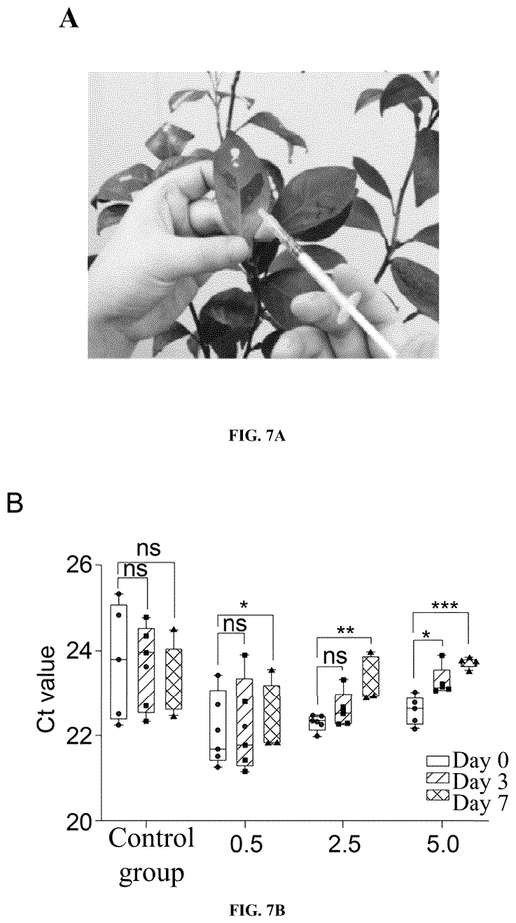

The leaves with consistent growth were selected from susceptible sweet orange seedlings; the bacteriostatic agent 1, bacteriostatic agent 2, and bacteriostatic agent 3 were injected into one side of the susceptible leaf with a midrib of the leaf as a boundary; while water was injected into the other side as a blank control. All plants were cultured under normal greenhouse conditions (FIG. 7A). After 3 d and 7 d, DNA was extracted from the leaves of the experimental group and the control group separately, and then the CLas content was detected (a bacterial content was expressed as a Ct value, which was negatively correlated with the bacterial content). There were at least 6 leaves per treatment, and the treatment experiments were repeated at least 3 times.

The results showed that after injection of bacteriostatic agent into the mesophyll, the CLas content gradually decreased on the 3rd and 7th day; and a higher concentration of the bacteriostatic agents 1 to 3 indicated a more significant bacteriostatic effect, and the bacteriostatic agent 1 showed the best effect; while after injection of water, the CLas content remained basically unchanged (FIG. 7B).

### Example 11 Significant Inhibition Of Clas by Trunk Injection with Bacteriostatic Agent 1

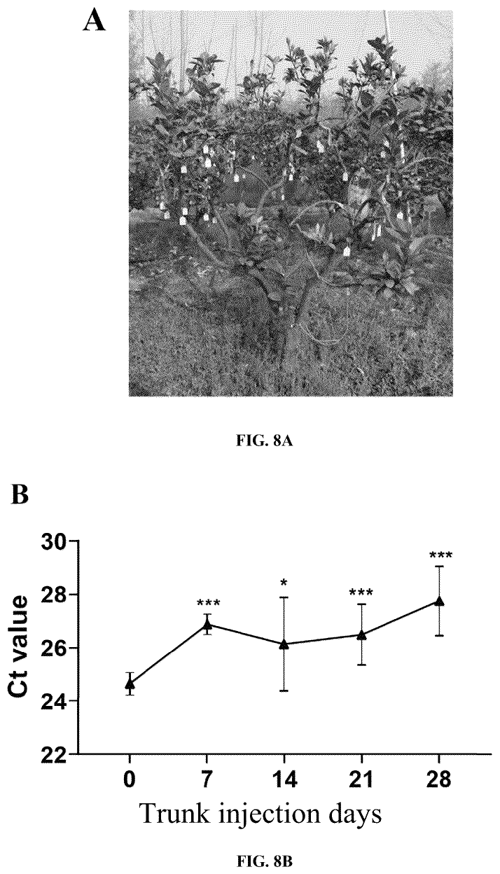

Through bacterial content detection, diseased trees with consistent bacterial content and desirable growth in susceptible orchards were selected as treatment targets. A hole at a base of the tree was drilled diagonally downward at a 45-degree angle to a depth of 3 cm to 5 cm with the same diameter as the needle. 250 mL of the bacteriostatic agent 1 was put into an injection bag and injected into the trunk through the drilled hole, and a flow rate was controlled to ensure that the bacteriostatic agent was gradually absorbed by the tree (FIG. 8A). Sampling and testing began 1 week after treatment, and the entire process lasted 4 weeks. During sampling, leaves were randomly collected from different parts of the tree for dynamic detection of CLas content (the bacterial content was expressed as a Ct value, which was negatively correlated with the bacterial content).

The results showed that the CLas content continued to significantly decrease within 4 weeks after injection of the bacteriostatic agent 1 into the trunk (FIG. 8B).

### Example 12 Trunk Injection of the Bacteriostatic Agent 1 Showing Desirable Therapeutic Effect on Multiple Commercial Citrus Varieties

HLB-infected trees of a total of 7 citrus varieties (Valencia orange, navel orange, sucarri orange, shatang mandarin, Orah mandarin, Eureka lemon, and Satsuma mandarin) were treated in the field by trunk injection of bacteriostatic agent 1. At least 120 HLB-infected trees of each variety were selected, of which 40 trees were regarded as one biological replicate, a total of three groups. The treatments lasted for 2 months, 1 time per month, while another 40 plants were given water injection as a control group. When the treatment was completed, the diseased trees were continuously observed, and the fruit quality was measured during the ripening stage.

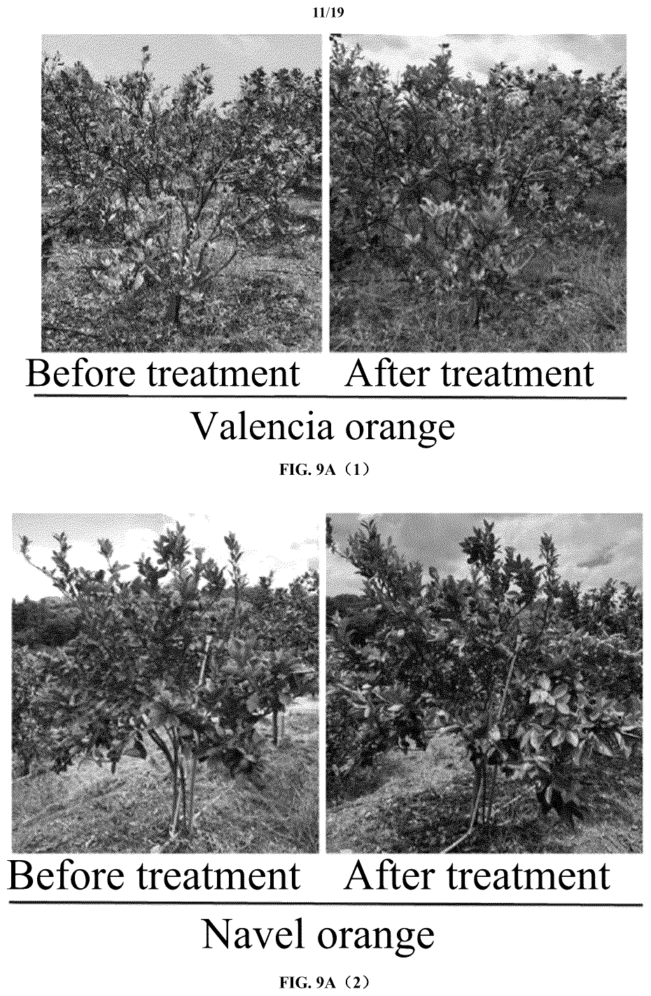

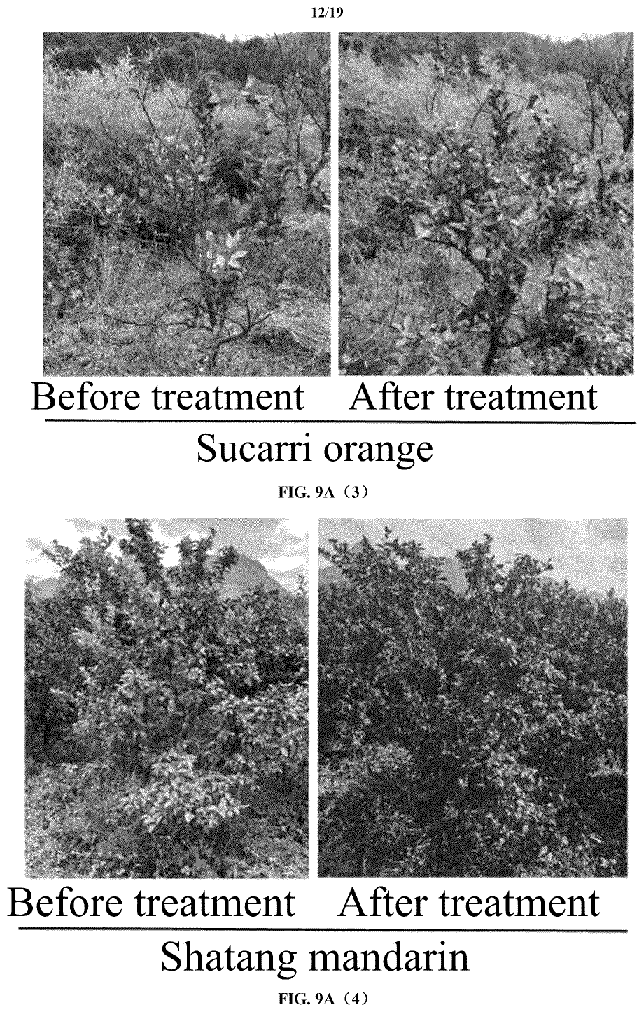

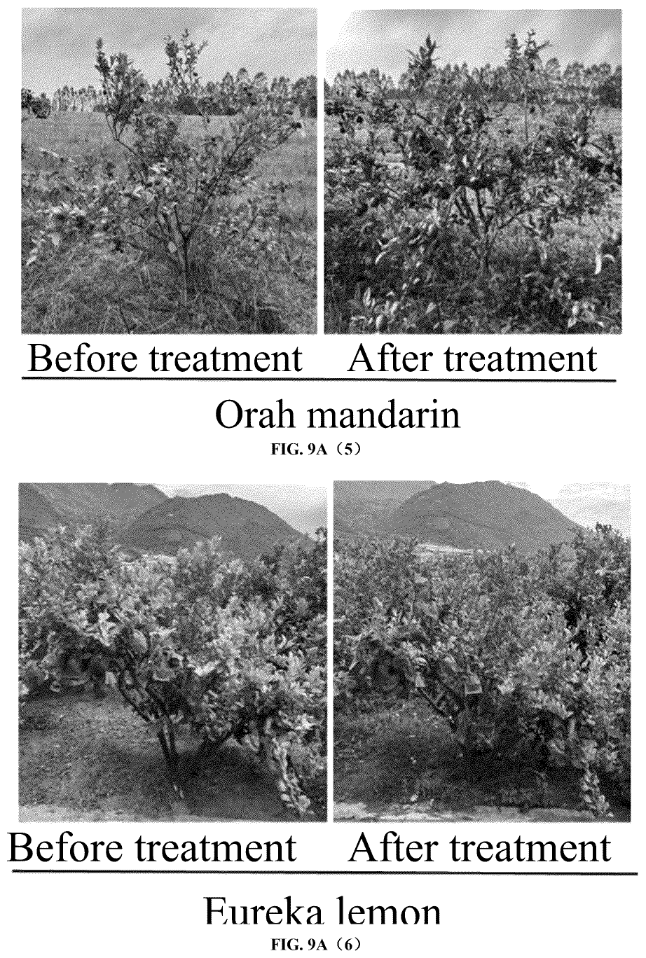

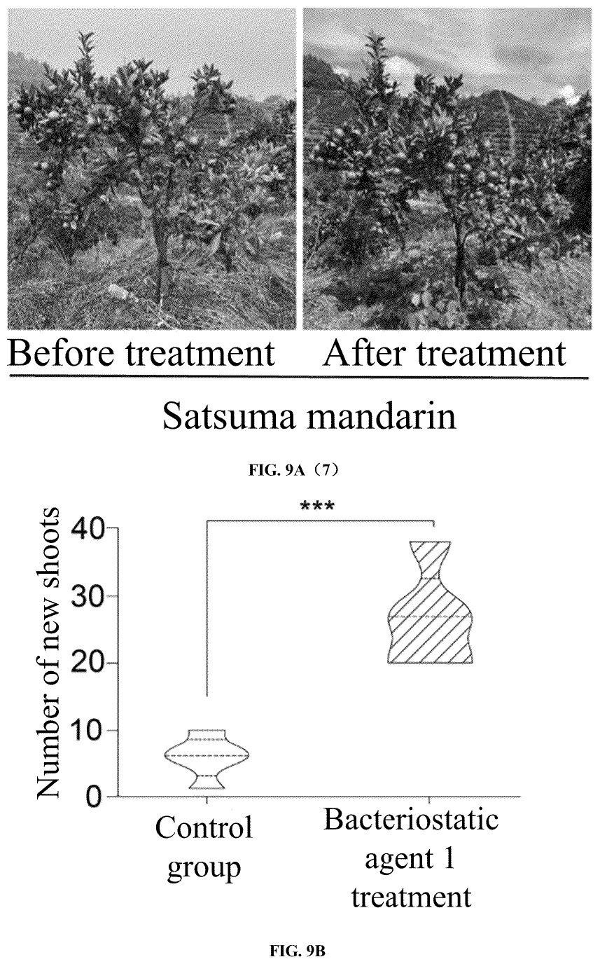

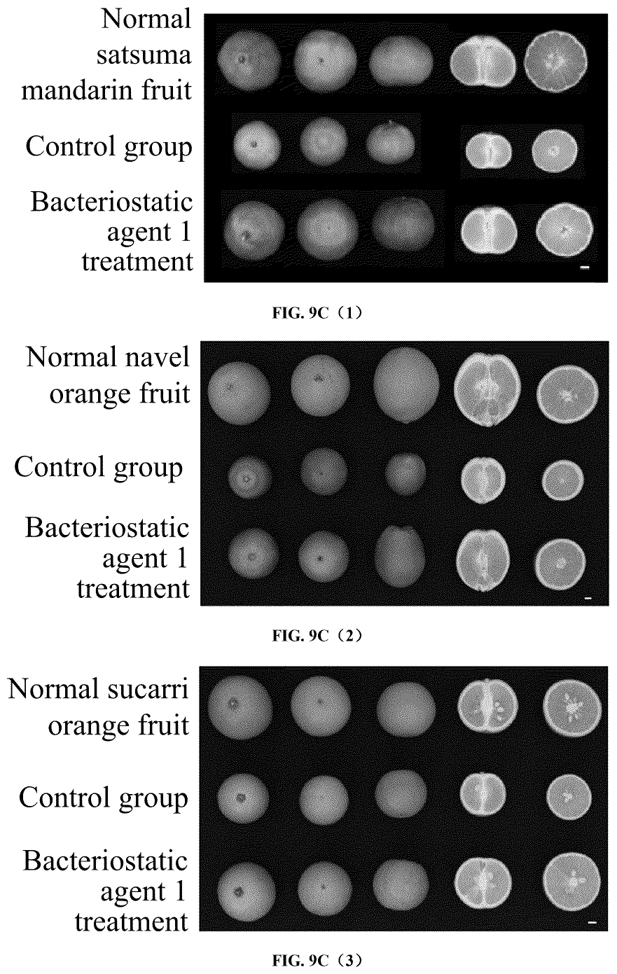

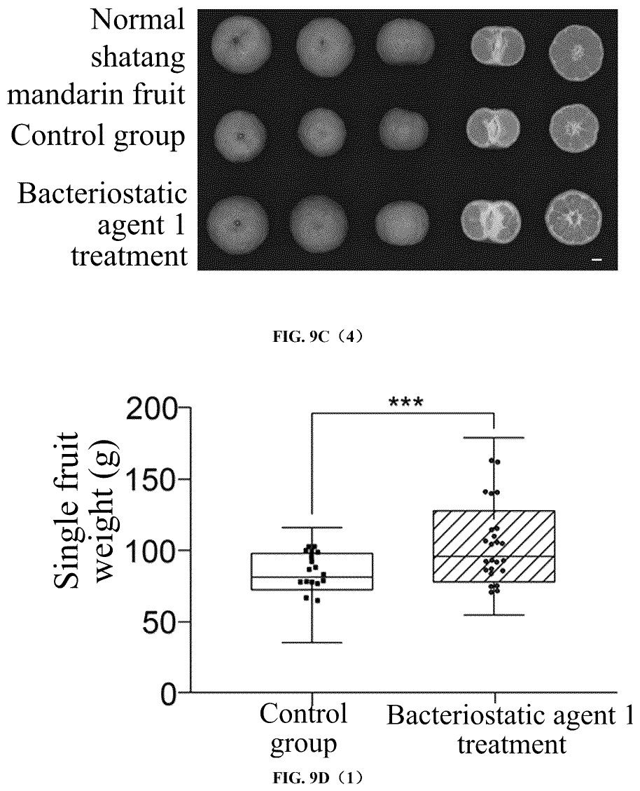

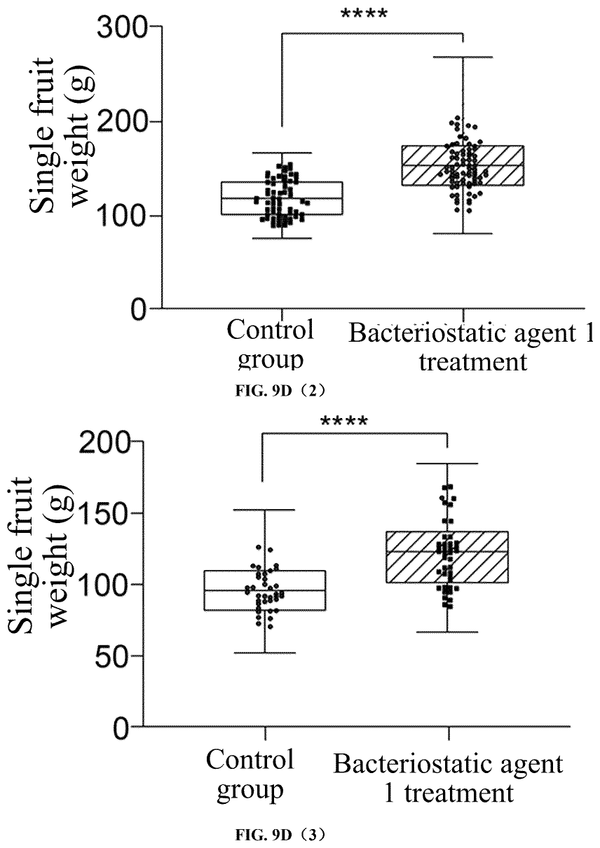

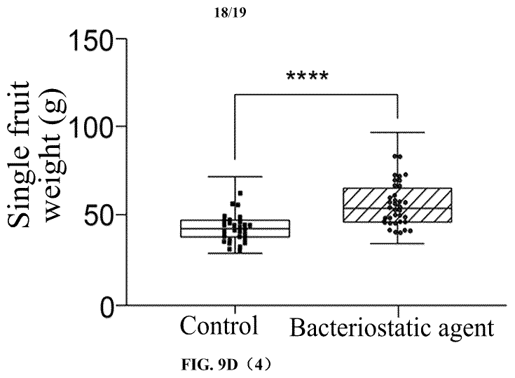

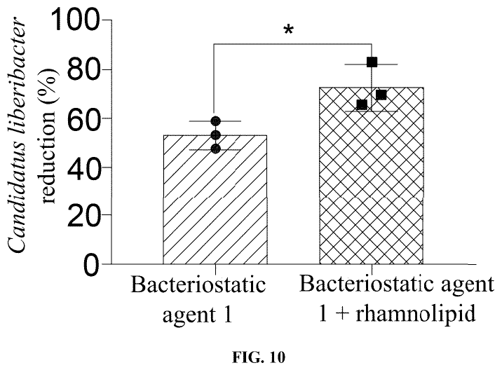

The results showed that the HLB-infected trees of 7 citrus varieties significantly increased their vigor after treatment with the bacteriostatic agent 1, their leaves turned green (FIG. 9A(1)-9A(7)), and a large number of healthy new shoots were extracted (FIG. 9B). Fruit quality measurement showed that the fruit size of diseased trees after treatment with the bacteriostatic agent 1 significantly increased (FIG. 9C(1)-9C(4) and FIG. 9D(1)-9D(4)).

### Example 13 Bacteriostatic Agent 4 Effectively Improving the Inhibitory Effect of CLas

The bacteriostatic agent 1 and bacteriostatic agent 4 were injected into the HLB-infected tree through trunk injection, and the bacteriostatic effects were compared.

The results showed that the antibacterial effect of the bacteriostatic agent 1 combined with rhamnolipid was better than that of the bacteriostatic agent 1 alone. The bacteriostatic agent 1 had the maximum bacteriostatic efficiency of 60%, while the bacteriostatic agent 4 could achieve the maximum bacteriostatic effect of 80%, which was a significant improvement (FIG. 10)

Other parts not described in detail are existing technologies. Although the above example has described the present disclosure in detail, it is only a part of, not all of, the examples of the present disclosure. Other examples may also be obtained by persons based on the example without creative efforts, and all of these examples shall fall within the protection scope of the present disclosure.

What is claimed is:

1. A method for controlling citrus huanglongbing (HLB), comprising using chlorogenic acid and a chlorogenic acid-rich substance.

2. The method according to claim 1, wherein the chlorogenic acid-rich substance is a green coffee bean extract.

3. A bacteriostatic agent for controlling Candidatus Liberibacter asiaticus (CLas), wherein the bacteriostatic agent comprises chlorogenic acid or a chlorogenic acid-rich substance, and the chlorogenic acid has an effective concentration of greater than or equal to 0.5 mg/mL.

4. The bacteriostatic agent according to claim 3, wherein the chlorogenic acid has an effective concentration of 0.5 mg/mL to 5.0 mg/mL.

5. The bacteriostatic agent according to claim 3, wherein the chlorogenic acid has an effective concentration of 5.0 mg/mL.

6. The bacteriostatic agent according to claim 3, wherein the bacteriostatic agent further comprises rhamnolipid.

7. The bacteriostatic agent according to claim 6, wherein the rhamnolipid in the bacteriostatic agent has an effective concentration of 1 mg/mL.

8. A method for inhibiting CLas, comprising: injecting the bacteriostatic agent according to claim 3 into a HLB-infected tree to be treated through leaf injection or trunk injection.

9. The method according to claim 8, specifically comprising the following steps:
when a citrus leaf is diseased, pricking a small hole on a back side of a diseased leaf with a needle, and injecting the bacteriostatic agent through a syringe to fill mesophyll cells; and/or,
when a citrus tree is HLB affected, drilling a hole at a base of the diseased citrus tree using an electric drill, and injecting a chlorogenic acid solution into an interior of the HLB-infected citrus tree through trunk injection, wherein an injection volume for each diseased citrus tree is adjusted to 200 mL to 350 mL according to a size of the diseased citrus tree.

10. The bacteriostatic agent according to claim 4, wherein the chlorogenic acid has an effective concentration of 5.0 mg/mL.
